(19) United States
(12) Patent Application Publication
(10) Pub. No.: US 2025/0350472 A1
(43) Pub. Date: Nov. 13, 2025

(54) PRODUCT AUTHENTICITY VERIFICATION SYSTEM AND METHOD FOR USING THE SAME

(71) Applicant: BrandsGuards Technology Co., Ltd., New Taipei City (TW)

(72) Inventor: Kenneth Liou, New Taipei City (TW)

(21) Appl. No.: 18/661,270

(22) Filed: May 10, 2024

(51) Int. Cl. H04L 9/32

(52) U.S. Cl. CPC H04L 9/3247; H04L 9/3228

(57) ABSTRACT

A product authenticity verification system and a method for using the same provide a three-layered anti-counterfeiting mechanism. First, verification is performed to determine whether a first identification code and a digital signature of a wireless identification tag are same as information stored in a database of a verification server. Second, a tag password verification operation, checked by the tag, needs to be passed before reading content of the tag. Third, a ciphertext and a second identification code for checking the tag are verified. When the above two operations are passed and a read count value of the tag is greater than that stored in the database, the server can determine authenticity of the tag. Because the tag requires the three-operation process each time for verification, and demands a correct password to read the content of the tag, the authenticity of the product and a trademark displayed thereon can be verified.

### BACKGROUND OF THE DISCLOSURE

### Field of the Disclosure

The present disclosure relates to a product authenticity verification system, and more particularly to a product authenticity verification system and a method for using the same, employing a technology for verifying authenticity of a product and a trademark displayed thereon using a wireless identification tag, a mobile device (running an application (APP)), and a server. After sensing the wireless identification tag, the mobile device can cooperate with the verification server and provide a three-layered anti-counterfeiting mechanism for verifying authenticity of the wireless identification tag.

### Brief Description of Related Art

In general, manufacturers attach wireless identification tags to their products in order to protect their products and trademarks displayed thereon from being counterfeited. Consumers can then use a mobile device to sense the wireless identification tag to view information about a source, quality, and a manufacturing history of a product. However, counterfeiters can still attach counterfeit wireless identification tags to counterfeit products in order to deceive consumers. In response to this problem, some inventors have conducted research and proposed the following solution:
(1) U.S. Patent Application Publication No. US20050049979 titled “Method, apparatus, and system for determining a fraudulent item” primarily involves writing an encryption password and product information encoded in advance into the wireless identification tag. Upon reading the wireless identification tag, consumers can verify whether the product information is that written by manufacturers when the product is manufactured. However, it is still possible for counterfeiters to directly copy information in the wireless identification tag, thereby maintaining the possibility for the wireless identification tag to be counterfeited.
(2) U.S. Pat. No. 11,106,783 titled “Systems and methods for authentication,” discloses an authentication method including exchanging authentication codes between a wireless tag and an authentication server for mutual authentication. A wireless tag reader acts as a communication bridge between the wireless tag and the authentication server, and can observe the mutual authentication between the tag device and the authentication server to confirm whether the wireless tag is trustworthy. However, the wireless tag reader merely acts as the communication bridge. Actual authentication operations occur between the wireless tag and the authentication server. An authentication process requires transmission of authentication data over a network. Thus, if a condition of the network is poor, resulting in a transmission delay, an authentication error can easily occur. Moreover, there is a possibility that data may be stolen during network transmission.
(3) U.S. Pat. No. 9,946,903 titled “Authenticity verification system and methods of use” discloses a method that involves writing identification (ID)-related information, a password, a read count, etc., into a read-write radio frequency identification (RFID) tag in advance. During verification of a product, a reading device is used to read information of the RFID tag to determine whether the information of the RFID tag exists in a database, thereby identifying whether the product is counterfeit. Additionally, varied ID-related information is rewritten into the RFID tag to enhance an anti-counterfeiting mechanism. However, an electronic device, due to different operating systems (Android, IOS), cannot write a request signal into the RFID tag, resulting in inability of the RFID tag to generate a variable key, which causes the system to malfunction.
(4) U.S. Pat. No. 10,146,969 titled “RFID tag and reader authentication by trusted authority” discloses a method for trusted transmission between a tag and a reader. However, the present disclosure proposes a three-layered anti-counterfeiting mechanism with more specific implementation. In addition, in order to ensure security of data during transmission, a time-based one-time password (TOTP) algorithm is also incorporated to prevent the data from being stolen.
(5) U.S. Pat. No. 10,387,695 titled “Authenticating and managing item ownership and authenticity” discloses a method that involves writing an ID and related information into a readable tag in advance, and writing the ID and the related information of the tag into an application (APP) of a reading device in advance. During verification of a product, the reading device is used to read information of the tag to determine whether the information of the tag exists in a database, thereby identifying whether the product is counterfeit. However, the method proposed in the present disclosure does not emphasize reading and writing of data in advance, but rather focuses on securing information transmission between an RFID tag and a verification system and preventing data from being stolen through a three-layered anti-counterfeiting mechanism.

As can be seen from the aforementioned wireless identification tag verification technologies, if the existing verification technology adopts the method of writing the password in advance, counterfeiters can directly copy the wireless identification tag and the password, rendering the anti-counterfeiting verification ineffective. Additionally, if the existing verification technology adopts the variable password method, the specialized reading device is needed to input the command into the wireless identification tag. And, due to limitations of the operating system, only reading but not writing is supported for the data format of the wireless identification tag. Thus, the anti-counterfeiting effect cannot be achieved. Therefore, a problem to be solved is how to provide a wireless identification tag that is not limited by an operating system, requires a three-operation process each time for verification, demands that a correct password be sent before content of the wireless identification tag is read, thereby ensuring secure information transmission.

### SUMMARY OF THE DISCLOSURE

In order to achieve the aforementioned objectives, the inventor proposes a “Product Authenticity Verification System and Method for Using the Same” based on a three-layered anti-counterfeiting mechanism that can fully utilize a mobile device to prevent counterfeiting of a wireless identification tag. The present disclosure proposes a verification system for preventing counterfeiting of a product and a trademark displayed thereon. The verification system is configured to verify authenticity of a wireless identification tag and includes a verification server, a database, and a mobile device. The mobile device has a processor, a first verification unit, a second verification unit, and a third verification unit. Upon execution of the aforementioned verification units, the processor can execute the following program instructions in sequence:
(1) sensing, by a mobile device, a wireless identification tag to obtain a first identification code and a digital signature; executing, by the mobile device, a time-based one-time password (TOTP) algorithm to generate a time-varying key based on a timestamp and a preset key of the mobile device; encrypting, by the mobile device, the first identification code and the digital signature with the time-varying key; and requesting, by the mobile device, that the verification server decrypt an encrypted version of the first identification code and an encrypted version of the digital signature which are sent by the mobile device based on a timestamp of the verification server and a pre-stored key corresponding to the preset key; and after the first identification code and the digital signature are obtained through decryption, verifying, by the verification server, whether a code corresponding to the first identification code and a signature corresponding to the digital signature are stored in a database; and when a first verification result is positive, encrypting, by the verification server, a wireless identification tag stored in the database, and transmitting, by the verification server, an encrypted version of the wireless identification tag back to the mobile device;
(2) sensing, by the mobile device, the wireless identification tag to issue a tag password verification command to the wireless identification tag; verifying, by the wireless identification tag, whether a decrypted version of the wireless identification tag password is correct; and when a second verification result is positive, transmitting, by the wireless identification tag, password verification success information back to the mobile device;
(3) sensing, by the mobile device, the wireless identification tag to issue a data read command to the wireless identification tag to obtain tag exchange data; verifying, by the mobile device, whether a second identification code included in the tag exchange data is same as the first identification code; and when a third verification result is positive, sending, by the mobile device, the tag exchange data to the verification server; then, requesting, by the mobile device that the verification server verify whether the second identification code and the tag-side ciphertext included in the tag exchange data are same as a code that corresponds to the second identification code and is pre-stored in the database, and a ciphertext that corresponds to the tag-side ciphertext and is pre-stored in the database, respectively; and when a fourth verification result is positive and the verification server determines that the read count value included in the tag exchange data is greater than a read count value stored in the database, updating, by the verification server, the read count value stored in the database, and transmitting, by the verification server, verification success information, product information, or a combination thereof back to the mobile device.

### BRIEF DESCRIPTION OF THE DRAWINGS

FIG. 1 is a block diagram of a verification system according to the present disclosure.

FIG. 2 is a flow chart that illustrates initialization for setting up the verification system according to the present disclosure.

FIG. 3 is an information flow chart (1) of the verification system according to the present disclosure.

FIG. 4 is a flowchart (1) of a verification method according to the present disclosure.

FIG. 5 is an information flow chart (2) of the verification system according to the present disclosure.

FIG. 6 is a flowchart (2) of the verification method according to the present disclosure.

FIG. 7 is an information flow chart (3) of the verification system according to the present disclosure.

FIG. 8 is a flowchart (3) of the verification method according to the present disclosure.

FIG. 9 is a flowchart (4) of the verification method according to the present disclosure.

### DETAILED DESCRIPTION OF PREFERRED EMBODIMENTS

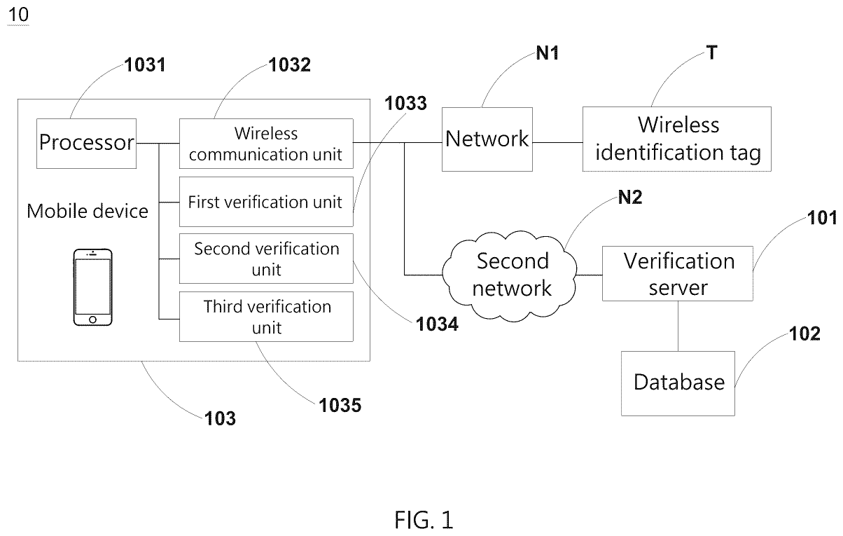

Referring to FIG. 1, the present disclosure has a verification system 10 for preventing counterfeiting of a product and a trademark displayed thereon. The verification system 10 is configured to verify authenticity of a wireless identification tag T and mainly includes a verification server 101, a database 102 coupled to the verification server 101, and a mobile device 103. The mobile device 103 can execute an application (APP) and connect to the wireless identification tag T through a network N1. The mobile device 103 can also execute the APP, causing the mobile device 103 to establish a communication link with the verification server 101 through a second network N2. The mobile device 103 has a processor 1031, and further has a wireless communication unit 1032, a first verification unit 1033, a second verification unit 1034, and a third verification unit 1035, each coupled to the processor 1031. The first verification unit 1033, the second verification unit 1034, and the third verification unit 1035 each store a plurality of program instructions that the processor 1031 can execute. The wireless communication unit 1032 can have a near-field communication (NFC) unit configured to allow the mobile device 103 to read information in the wireless identification tag T. The wireless communication unit 1032 can further have a network communication unit configured to allow the mobile device 103 to connect to the verification server 101.

Furthermore, the network N1 can be, for example, an NFC network, and the second network N2 can be a public or private network, such as a wireless network (third generation (3G), fourth generation (4G) Long-term evolution (LTE), wireless fidelity (Wi-Fi)), a wired network, a local area network (LAN), or a wide area network (WAN). But the present disclosure is not limited thereto.

Moreover, the mobile device 103 can be a handheld computer, a smart phone, a tablet computer, or the like. An operating system of the mobile device 103 can be an Android system or an iOS system. But the present disclosure is not limited thereto.

In addition, the verification server 101 can be a stand-alone server computer providing connection services, a virtual machine (VM) installed and running in a server computer, a server running in the form of a virtual private server (VPS), a public cloud, a private cloud, an edge device, or the like. But the present disclosure is not limited thereto.

Furthermore, the processor 1031 can be a central processing unit (CPU), a microprocessor unit (MPU), a microcontroller unit (MCU), an application processor (AP), an embedded processor, or an application specific integrated circuit (ASIC). But the present disclosure is not limited thereto.

Moreover, the database 102 can itself be a physical database host, or a relational or non-relational database stored in the verification server 101 in the form of multiple tables. But the present disclosure is not limited thereto.

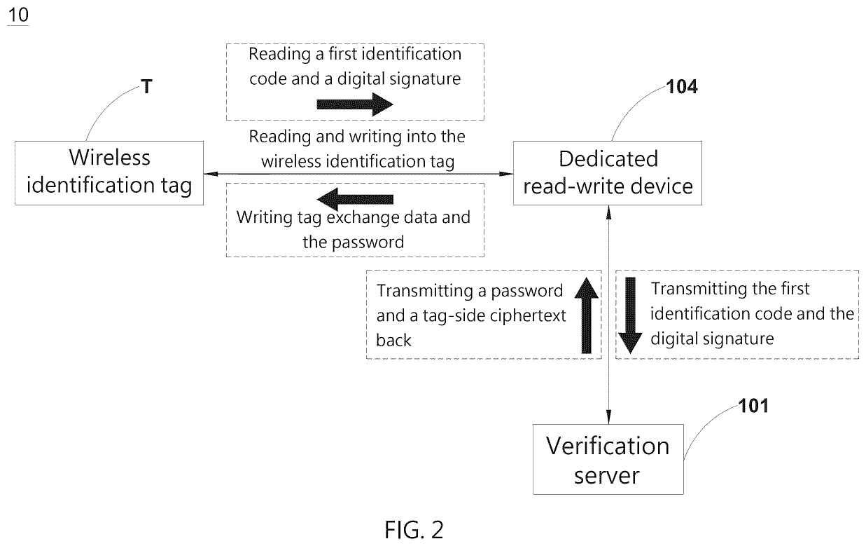

Referring to FIG. 2 in conjunction with FIG. 1, in the present disclosure, a dedicated read-write device 104 that communicates with the verification server 101 can perform an initialization operation on the wireless identification tag T before the wireless identification tag T is verified. First, the dedicated read-write device 104 can read a first identification code and a digital signature of the wireless identification tag T, and transmits them to the database 102 of the verification server 101 via the Internet for storage. Then, the verification server 101 calculates a wireless identification tag password and a tag-side ciphertext using a hash algorithm, for example, and transmits them back to the dedicated read-write device 104. Then, the dedicated read-write device 104 writes the wireless identification tag password and tag exchange data transmitted back from the verification server 101 into the wireless identification tag T, thereby completing the initialization operation performed on the wireless identification tag T, and consequently generating a dedicated and unique wireless identification tag T. If the wireless identification tag T is an NFC tag, the tag exchange data mentioned in the present disclosure can be stored in memory of the wireless identification tag T in the form of a near-field communication data exchange format (NDEF).

The dedicated read-write device 104 can be a handheld computer, a smart phone, a tablet computer, or the like. But the present disclosure is not limited thereto.)

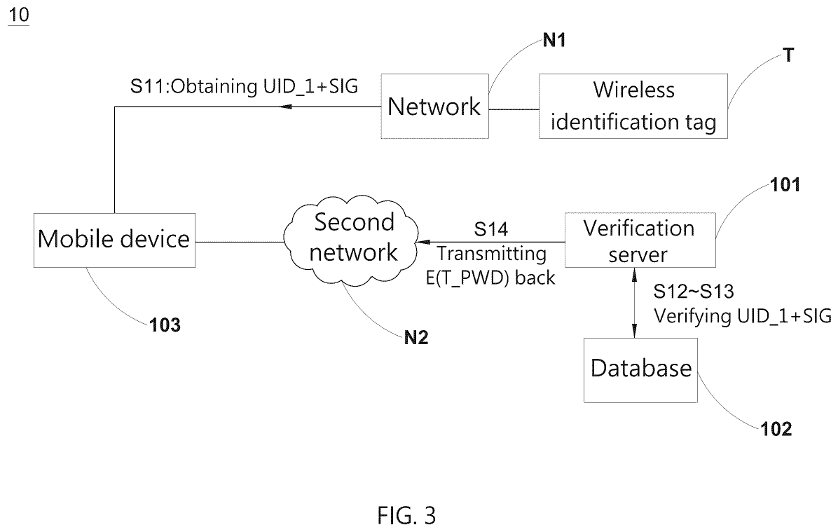

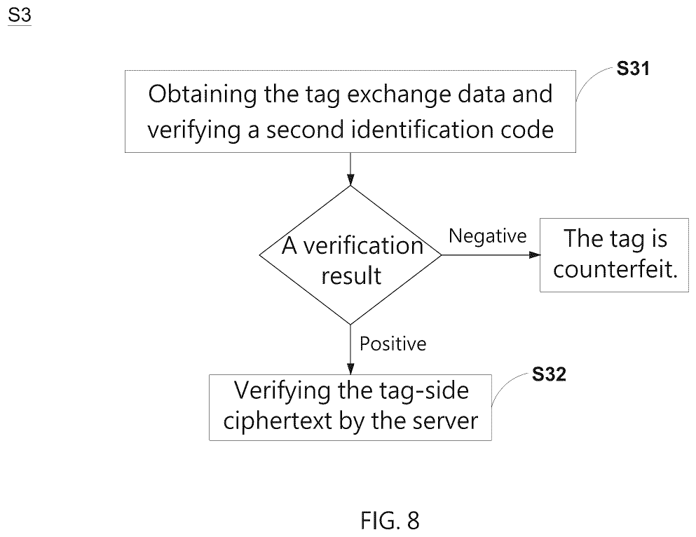

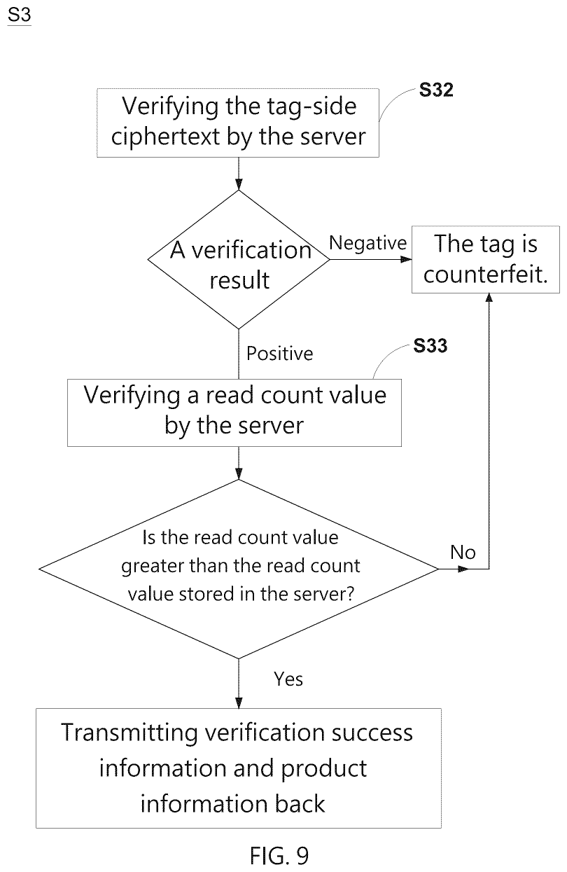

Referring to FIGS. 3 to 9 at the same time, in the present embodiment, the processor 1031 of the verification system 10 can drive the first verification unit 1033, the second verification unit 1034, and the third verification unit 1035 to perform verification to prevent counterfeiting of the product and the trademark displayed thereon. The aforementioned verification method is applicable to a verification system (i.e., the aforementioned verification system 10 for preventing counterfeiting of the product and the trademark displayed thereon) including a wireless identification tag T, a mobile device 103, and a verification server 101. The verification system 10 performs the following operations S1 to S3.

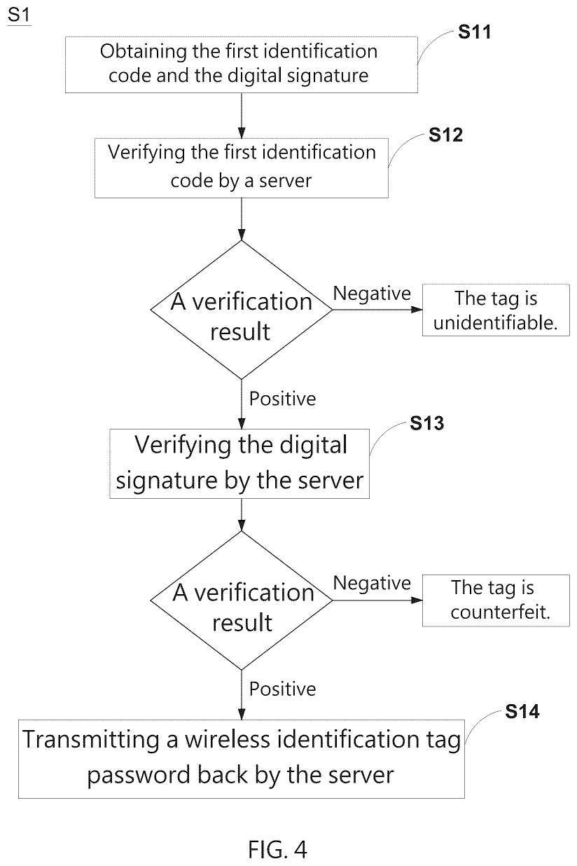

Referring to FIGS. 3 and 4 in conjunction with FIG. 1, the operation S1 (verifying the first identification code and the digital signature) includes the following operations:
(1) An operation of obtaining the first identification code and the digital signature (an operation S11): The first verification unit 1033 can drive the mobile device 103 to execute the APP, causing the mobile device 103 to connect to the wireless identification tag T through the network N1, sense the wireless identification tag T, obtain a first identification code UID_1 and a digital signature SIG from the wireless identification tag T, execute a time-based one-time password (TOTP) algorithm to generate a time-varying key (i.e., an encryption key) based on a preset key (e.g., “Henry123”) of the mobile device 103 and a timestamp of the mobile device 103 for a current time, and encrypt the first identification code UID_1 and the digital signature SIG with the time-varying key (e.g., through an advanced encryption standard (AES)-256 algorithm). That is, the mobile device 103 can perform an encryption algorithm based on a key that varies over time. Subsequently, the mobile device 103 is driven to execute the APP, causing the mobile device 103 to connect to the verification server 101 through the second network N2. Then, the verification server 101 can calculate three time-varying keys (i.e., decryption keys) based on a timestamp of the verification server 101 for a current time, a timestamp of the verification server 101 for a time prior to the current time by a time interval, and a timestamp of the verification server 101 for a time following the current time by the time interval, respectively, and a preset key (e.g., “Henry123”) pre-stored in the database 102, using the TOTP algorithm. The verification server 101 decrypts an encrypted version of the first identification code UID_1 and an encrypted version of the digital signature SIG which are sent by the mobile device 103 using each of the three time-varying keys until successful decryption is achieved using one of the three time-varying keys. After the verification server 101 obtains the original first identification code UID_1 and the digital signature SIG through decryption, the verification server 101 can proceed to an operation S12.
(2) An operation of verifying the first identification code by the server (the operation S12): The verification server 101 verifies whether a code corresponding to the first identification code UID_1 is stored in the database 102. If a verification result is negative, the verification server 101 transmits an unidentifiable message back to the mobile device 103 through the second network N2. If the verification result is positive, the verification server 101 proceeds to an operation S13.
(3) An operation of verifying the digital signature by the server (the operation S13): The verification server 101 verifies whether a signature corresponding to the digital signature SIG is stored in the database 102. If a verification result is negative, the verification server 101 transmits a counterfeit-tag message back to the mobile device 103 through the second network N2. If the verification result is positive, the verification server 101 proceeds to an operation S14.
(4) an operation of transmitting a wireless identification tag password back by the server (the operation S14): the verification server 101 encrypts a wireless identification tag password T_PWD stored in the database 102 using, for example, an AES-256 algorithm (for example, the verification server 101 can use the time-varying key calculated using the TOTP algorithm based on the aforementioned preset key and timestamp of the server for encryption), and then transmits an encrypted version of the wireless identification tag password E(T_PWD) back to the mobile device 103.
(5) Based on the above, the first identification code UID_1 can be a unique identifier (UID). And the digital signature SIG is mainly generated by a wireless identification tag manufacturer using a key of the manufacturer through an encryption algorithm at the time of tag production. Furthermore, the digital signature SIG can be stored in the wireless identification tag T in a format such as a signature record type definition (RTD).
(6) Based on the above, for the verification server 101 to successfully perform decryption during the operation S11, an error between the timestamp of the verification server 101 and the timestamp of the mobile device 103 can be kept within a tolerance value. Typically, the first identification code UID_1 and the digital signature SIG stored by the verification server 101 are in plaintext. Therefore, by using a cryptographic algorithm (such as AES-256), it is possible to prevent a malicious actor from successfully intercepting the first identification code UID_1 and the digital signature SIG between the verification server 101 and the mobile device 103. More specifically, in the present disclosure, during execution of the operation S11, the mobile device 103 can generate the time-varying key based on the timestamp for the current time (e.g., 00:00:30) using the TOTP algorithm. The verification server 101 can generate the three time-varying keys by performing the TOTP algorithm on the preset key based on the timestamp for the current time, as well as on a first time interval (e.g., the next 30 seconds) and a second time interval (e.g., the previous 30 seconds), so that the verification server 101 can successfully obtain the first identification code UID_1 and the digital signature SIG through decryption using one of the time-varying keys.
(7) Based on the above, in the operation S14, the verification server 101 uses the time-varying key that can successfully obtain the first identification code UID_1 and the digital signature SIG through decryption in the operation S11 to perform encryption of the tag password.

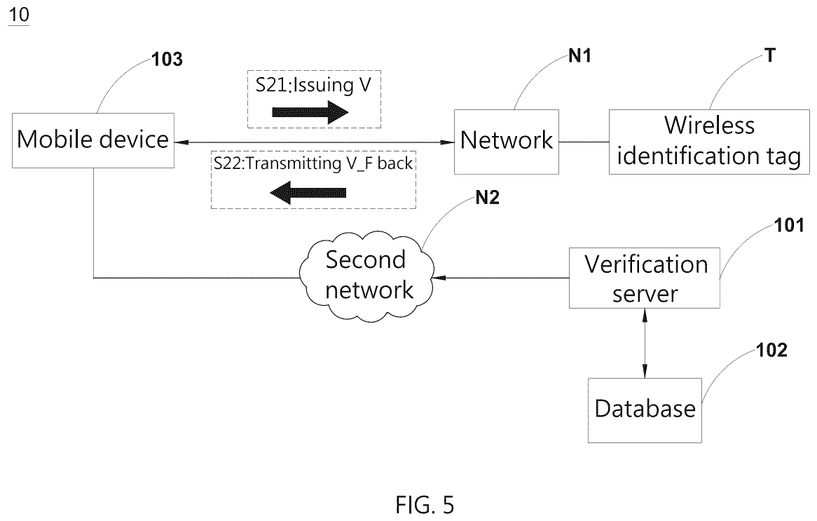

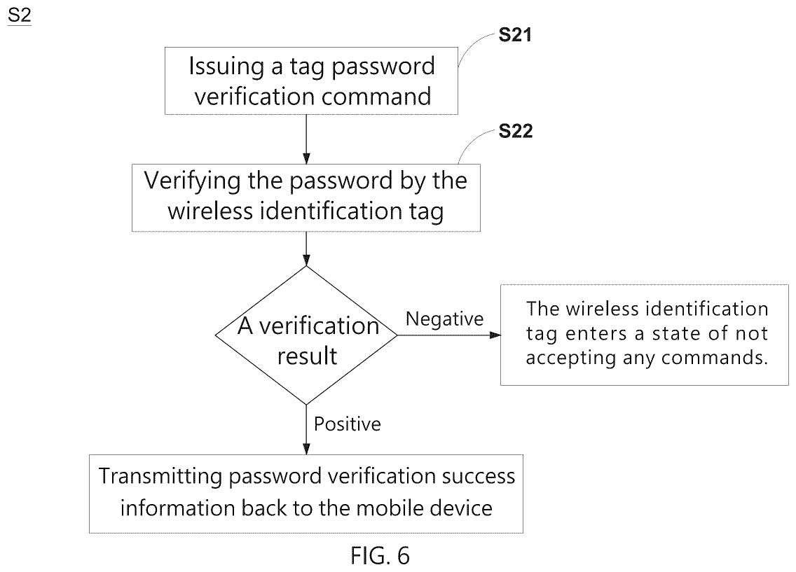

Referring to FIGS. 5 and 6 in conjunction with FIGS. 1 and 3, the operation S2 (verifying the wireless identification tag password) includes the following operations:
(1) An operation of issuing a tag password verification command (an operation S21): upon execution of the second verification unit 1034, the processor 1031 causes the mobile device 103 to decrypt the encrypted version of the wireless identification tag password E(T_PWD) using, for example, the AES-256 algorithm (for example, based on the time-varying key generated by the mobile device 103 in the operation S11, which is not further elaborated here), to generate a decrypted version of the wireless identification tag password T_PWD. Subsequently, the mobile device 103 is driven to execute the APP, causing the mobile device 103 to connect to the wireless identification tag T through the network N1 so that upon sensing the wireless identification tag T, the mobile device 103 issues the tag password verification command V to the wireless identification tag T. Then, the wireless identification tag T proceeds to an operation S22.
(2) An operation of verifying the password by the wireless identification tag (the operation S22): The wireless identification tag T verifies whether the decrypted version of the wireless identification tag password T_PWD is correct. If a verification result is negative, the wireless identification tag T enters a state of not accepting any commands. Additionally, to prevent brute-force password attacks, there is a limit on a number of consecutive failed password verifications, and when the number of consecutive failed password verifications exceeds a preset number, the wireless identification tag T can no longer be read. If the verification result is positive, the wireless identification tag T transmits password verification success information V_F back to the mobile device 103.

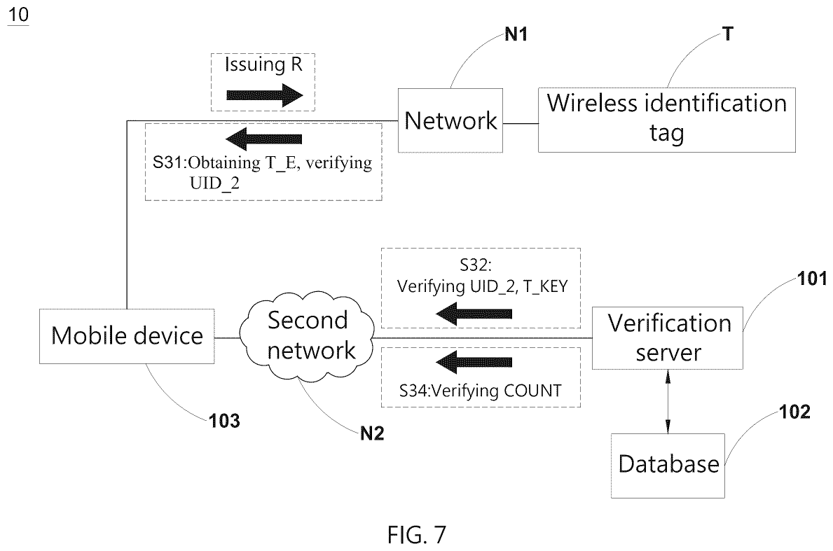

Referring to FIGS. 7 to 9 in conjunction with FIG. 1, the operation S3 (verifying a second identification code, a tag-side ciphertext, and a read count value) includes the following operations:
(1) An operation of obtaining the tag exchange data and verifying the second identification code (an operation S31): The third verification unit 1035 can drive the mobile device 103 to execute the APP, causing the mobile device 103 to connect to the wireless identification tag T through the network N1, so that upon sensing the wireless identification tag T, the mobile device 103 issues a data read command R to the wireless identification tag T to obtain the tag exchange data T_E. Subsequently, the mobile device 103 verifies whether the second identification code UID_2 included in the tag exchange data T_E is same as the first identification code UID_1. If a verification result is negative, the mobile device 103 determines that the tag should be counterfeit and displays a counterfeit-tag message. If the verification result is positive, the mobile device 103 can further send the tag exchange data T_E to the verification server 101, so that the verification server 101 proceeds to an operation S32.
(2) An operation of verifying the tag-side ciphertext by the server (the operation S32): The verification server 101 verifies whether the tag-side ciphertext T_KEY included in the tag exchange data T_E is same as a ciphertext that corresponds to the tag-side ciphertext T_KEY and is pre-stored in the database 102. If a verification result is negative, the verification server 101 transmits a counterfeit-tag message back to the mobile device 103 through the second network N2. If the verification result is positive, the verification server 101 proceeds to an operation S33.
(3) An operation of verifying the read count value by the server (the operation S33): The verification server 101 determines whether the read count value COUNT included in the tag exchange data T_E is greater than a read count value COUNT stored in the database 102. If a comparison result is positive, the verification server 101 updates the read count value COUNT stored in the database 102 and transmits verification success information, product information, or a combination thereof back to the mobile device 103. If the comparison result is negative, the verification server 101 transmits incorrect-read count value information back the mobile device 103, so that the mobile device 103 displays a counterfeit-tag message.
(4) Based on the above, the second identification code UID_2 can be a mirror UID, and the second identification code UID_2 should be a mirrored value of the first identification code UID_1.

Further, the present disclosure further provides a computer program product that can execute the aforementioned verification method for preventing counterfeiting of the product and the trademark displayed thereon. When a plurality of program instructions of the computer program product are loaded into a computer system, the operations S1 to S3 of the aforementioned method for preventing counterfeiting of the product and the trademark displayed thereon can at least be completed.

Based on the above, upon implementation, the present disclosure can at least achieve the following advantageous effects:
(1) By employing a three-layered anti-counterfeiting mechanism and utilizing a verification mode between the mobile device, the wireless identification tag, and the verification server, direct copying of the wireless identification tag by unscrupulous operators can be prevented, thereby achieving an excellent anti-counterfeiting effect.
(2) Because the wireless identification tag requires the three-operation process each time for verification, and also demands a correct password to read content of the wireless identification tag, counterfeiting of the wireless identification tag is effectively prevented.

The above is only the preferred embodiments of the present disclosure, and is not intended to limit the present disclosure to the forms disclosed. Any modifications, equivalent alternatives, and improvements made within the spirit and the scope of present disclosure by persons skilled in the art should be included in the scope of claims of the present disclosure.

### REFERENCE SIGN

10 a verification system
101 a verification server
E(T_PWD) an encrypted version of the wireless identification tag password
102 a database
103 a mobile device
1031 a processor
1032 a wireless communication unit
1033 a first verification unit
1034 a second verification unit
1035 a third verification unit
V a tag password verification command
R a data read command
104 a dedicated read-write device
T a wireless identification tag
UID_1 a first identification code
SIG a digital signature
T_PWD a wireless identification tag password
V_F password verification success information
T_E tag exchange data
UID_2 a second identification code
T_KEY a tag-side ciphertext
COUNT a read count value
N1 a network
N2 a second network
S1 an operation of verifying a first identification code and a digital signature
S11 an operation of obtaining the first identification code and the digital signature
S12 an operation of verifying the first identification code by a server
S13 an operation of verifying the digital signature by the server
S14 an operation of transmitting a wireless identification tag password back by the server
S2 an operation of verifying the wireless identification tag password
S21 an operation of issuing a tag password verification command
S22 an operation of verifying the password by the wireless identification tag
S3 an operation of verifying a second identification code, a tag-side ciphertext, and a read count value
S31 an operation of obtaining tag exchange data and verifying the second identification code
S32 an operation of verifying the tag-side ciphertext by the server
S33 an operation of verifying the read count value by the server

What is claimed is:

1. A product authenticity verification system configured to verify authenticity of a wireless identification tag, wherein the system comprises:
a verification server coupled to a database;
a mobile device having a processor, wherein the processor is coupled to a first verification unit, a second verification unit, and a third verification unit, wherein the first verification unit, the second verification unit, and the third verification unit each stores a plurality of program instructions that the processor executes, and wherein the mobile device has an application (APP) stored thereon;
wherein the first verification unit is configured to drive the mobile device to execute the APP, causing the mobile device to connect to the wireless identification tag through a network, obtain a first identification code and a digital signature, and encrypt the first identification code and the digital signature with a time-varying key generated by a time-based one-time password (TOTP) algorithm; and drive the mobile device to execute the APP, causing the mobile device to connect to the verification server through a second network, request the verification server to decrypt, based on a key corresponding to the time-varying key, an encrypted version of the first identification code and an encrypted version of the digital signature, to verify whether a code corresponding to the first identification code and a signature corresponding to the digital signature are stored in the database, and when a first verification result is positive, to encrypt a wireless identification tag password stored in the database, and to transmit an encrypted version of the wireless identification tag password back to the mobile device through the second network;
wherein the second verification unit is configured to drive the mobile device to execute the APP, causing the mobile device to issue a tag password verification command to the wireless identification tag to request the wireless identification tag to verify whether a decrypted version of the wireless identification tag password is correct, and when a second verification result is positive, to transmit password verification success information back to the mobile device through the network; and
wherein the third verification unit is configured to drive the mobile device to execute the APP, causing the mobile device to issue a data read command to the wireless identification tag through the network to obtain tag exchange data comprising a second identification code, a tag-side ciphertext, and a read count value, and verify whether the second identification code is same as the first identification code, and when a third verification result is positive, execute the APP, causing the mobile device to send the tag exchange data to the verification server through the second network and request the verification server to verify whether a ciphertext corresponding to the tag-side ciphertext is stored in the database and obtain a fourth verification result;
wherein when the fourth verification result is positive, and the verification server determines that the read count value is greater than a read count value stored in the database, the verification server updates the read count value stored in the database and transmits verification success information, product information, or a combination thereof back to the mobile device.

2. The product authenticity verification system of claim 1, wherein the mobile device further comprises a wireless communication unit coupled to the processor, and the wireless communication unit has a near-field communication (NFC) unit configured to allow the mobile device to read information in the wireless identification tag.

3. The product authenticity verification system of claim 1, wherein the read count value in the tag exchange data is automatically incremented each time the mobile device completes sensing through the network.

4. The product authenticity verification system of claim 1, wherein the wireless identification tag password is used to protect an ability to read the wireless identification tag based on the data read command, and additionally, there is a limit on a number of consecutive failed password verifications, and when the number of consecutive failed password verifications exceeds a preset number, reading the wireless identification tag is no longer possible.

5. The product authenticity verification system of claim 1, wherein upon execution of the first verification unit, the first identification code and the digital signature are encrypted with the time-varying key that is composed of a timestamp of the mobile device and a preset key; and the verification server generates three keys corresponding to the time-varying key with a timestamp for a current time, a timestamp for a time prior to the current time by a time interval, and a timestamp for a time following the current time by the time interval, respectively, based on the TOTP algorithm, and encrypts the wireless identification tag password with the one of the three keys that enables successful decryption.

6. The product authenticity verification system of claim 1, wherein when the first verification result of the first verification unit is negative, the verification server transmits a first unidentifiable message or a first counterfeit-tag message back to the mobile device through the second network, and when the fourth verification result of the third verification unit is negative, the verification server transmits a second unidentifiable message or a second counterfeit-tag message back to the mobile device through the second network.

7. A method for using a product authenticity verification system, wherein the method comprises:
an operation of verifying a first identification code and a digital signature: sensing, by a mobile device, a wireless identification tag to obtain a first identification code and a digital signature; executing, by the mobile device, a time-based one-time password (TOTP) algorithm to generate a time-varying key based on a timestamp and a preset key of the mobile device; and encrypting, by the mobile device, the first identification code and the digital signature with the time-varying key; and then decrypting, by a verification server, an encrypted version of the first identification code and an encrypted version of the digital signature which are sent by the mobile device based on a key corresponding to the time-varying key, wherein the key corresponding to the time-varying key is composed of a timestamp of the verification server and a pre-stored key corresponding to the preset key; and after the first identification code and the digital signature are obtained through decryption, verifying, by the verification server, whether a code corresponding to the first identification code and a signature corresponding to the digital signature are stored in a database; and when a first verification result is positive, encrypting, by the verification server, a wireless identification tag stored in the database, and transmitting, by the verification server, an encrypted version of the wireless identification tag back to the mobile device;
an operation of verifying the wireless identification tag password: sensing, by the mobile device, the wireless identification tag to issue a tag password verification command to the wireless identification tag; verifying, by the wireless identification tag, whether a decrypted version of the wireless identification tag password is correct; and when a second verification result is positive, transmitting, by the wireless identification tag, password verification success information back to the mobile device; and
an operation of verifying a second identification code, a tag-side ciphertext, and a read count value: sensing, by the mobile device, the wireless identification tag to issue a data read command to the wireless identification tag to obtain tag exchange data; verifying, by the mobile device, whether the second identification code comprised in the tag exchange data is same as the first identification code; and when a third verification result is positive, sending, by the mobile device, the tag exchange data to the verification server; verifying, by the verification server, whether the tag-side ciphertext comprised in the tag exchange data is same as a ciphertext that corresponds to the tag-side ciphertext and is pre-stored in the database; and when a fourth verification result is positive and the verification server determines that the read count value comprised in the tag exchange data is greater than a read count value stored in the database, updating, by the verification server, the read count value stored in the database, and transmitting, by the verification server, verification success information, product information, or a combination thereof back to the mobile device.

8. The method for using a product authenticity verification system of claim 7, wherein when executing the operation of verifying the first identification code and the digital signature, the verification server generates three keys corresponding to the time-varying key with a timestamp for a current time, a timestamp for a time prior to the current time by a time interval, and a timestamp for a time following the current time by the time interval, respectively, using the TOTP algorithm, and encrypts the wireless identification tag password with the one of the three keys that enables successful decryption.

9. The method for using a product authenticity verification system of claim 7, wherein when executing the operation of verifying the second identification code, the tag-side ciphertext, and the read count value, the verification server, when verifying whether the ciphertext corresponding to the tag-side ciphertext is stored in the database, concurrently verifies whether a code corresponding to the second identification code is stored in the database.

10. The method for using a product authenticity verification system of claim 7, wherein the read count value in the tag exchange data is automatically incremented each time the mobile device completes sensing through the network.
